(19) United States
(12) Patent Application Publication
(10) Pub. No.: US 2016/0322062 A1
(43) Pub. Date: Nov. 3, 2016

(54) SPEECH PROCESSING METHOD AND SPEECH PROCESSING APPARATUS

(71) Applicant: Yulong Computer Telecommunication Scientific (Shenzhen) Co., Ltd., Shenzhen (CN)

(72) Inventor: Changning Li, Shenzhen (CN)

(21) Appl. No.: 15/206,410

(22) Filed: Jul. 11, 2016

Related U.S. Application Data
(63) Continuation-in-part of application No. PCT/CN2014/070641, filed on Jan. 15, 2014.

(51) Int. Cl. G10L 21/0216; H04R 3/00; G10L 21/0264; H04R 3/04; H04R 1/40

(52) U.S. Cl. CPC G10L 21/0216; H04R 3/04; H04R 1/406; G10L 21/0264; H04R 3/005; H04R 2430/20; G10L 2021/02166

(57) ABSTRACT

A speech processing method and apparatus for speech processing is provided. The speech processing method includes: acquiring position data variations of a sound collection unit array on a terminal relative to a user sound source; correcting DOA of the sound collection unit array on the basis of the position data variations; and performing filter processing on sound signals acquired by the sound collection unit. Through the method, a noise reduction algorithm is provided with self-adaptive ability, and some parameters of the noise reduction algorithm can be regulated self-adaptively at any time on the basis of random changes in postures of a user during a communication process.

### CROSS-REFERENCE TO RELATED APPLICATIONS

This application is a continuation-in-part of PCT Patent Application No. PCT/CN2014/070641, entitled “SPEECH PROCESSING METHOD AND SPEECH PROCESSING APPARATUS”, filed on Jan. 15, 2014, which is hereby incorporated in its entirety by reference.

### TECHNICAL FIELD

The present disclosure relates to communication technology field, and particularly to a speech processing method and a speech processing apparatus.

### BACKGROUND

To improve quality of voice communication of mobile phones, mobile phone manufacturers often improve quality of voice communication by increasing the number of microphones. For example, there are two-microphone mobile terminals and three-microphone mobile terminals. Noise reduction in changing environments, such as signal variations in space or time, has brought great challenge to the computing capability of the hardware of a mobile terminal (such as a mobile phone), and can also increase power consumption.

### SUMMARY

Based on the above problems, the present disclosure provides a new speech processing method, which acquires orientation variation information of a terminal in a communication process, and corrects certain parameters of a speech noise reduction algorithm based on a multiple microphone array in time according to these information, thereby causing the noise reduction algorithm to be self-adaptive and adjusting certain parameters of the noise reduction algorithm at any time with random changes in postures of the user during a communication process self-adaptively.

In view of this, according to one aspect of the present disclosure, a speech processing method is provided. The speech processing method includes: acquiring position data variations of a sound collection unit array on a terminal relative to a user sound source, correcting direction of arrival (DOA) of the sound collection unit array according to the position data variations, and performing filter processing on sound signals acquired by the sound collection unit.

The sound collection unit array signal processing method is a space-time signal processing method. Speech signals and various noise signals received by the sound collection unit are from different spatial orientations, thus if spatial orientation information is taken into consideration, signal processing ability may be greatly improved. The noise reduction solution based on a multiple sound collection unit array is that the sound collection unit array is expected to extract speech signals from the user sound source, and ignore noise signals from other directions, thereby achieving the purpose of noise reduction.

More particularly, the sound collection unit array is to form a wave beam in a space which points to the direction of the user sound source and can filter sound from other directions. The beam forming depends on the position of the sound collection unit array relative to the user sound source. By means of the technical solution, DOA of the sound collection unit array is corrected based on the acquired position data variations of the sound collection unit array of the terminal relative to the user sound source. No matter how the position of the terminal relative to the user sound source changes, sound signals from the direction of the user sound source can be always extracted, such that the noise reduction purpose can be achieved, that is, certain parameters of the noise reduction algorithm can be adjusted self-adaptively at any time with random changes in postures of a user during a communication process, thereby achieving the best noise reduction effect.

In the above technical solution, preferably, position data variations of the sound collection unit array are acquired by the use of a gyroscope of the terminal. Wherein, the position data variations include a displacement variation of a reference sound collection unit and an angle variation of the sound collection unit array line.

By means of the technical solution, during the use of a terminal such as a mobile phone, the relative position of the user sound source and the sound collection unit changes randomly. Presently, most mobile phones include a gyroscope. The gyroscope can provide accurate information of acceleration speed and angle variation, thus in the present disclosure the gyroscope is used to obtain the position data variations of the sound collection unit array, and accurate position data variations can be acquired. Also, existing hardware devices of the terminal can be fully utilized, and there is no need to add additional hardware devices, thus noise reduction effect can be improved, and meanwhile hardware cost is reduced.

In the above technical solution, preferably, the step of correcting DOA of the sound collection unit array according to the position data variations includes acquiring initial position data of the reference sound collection unit of the sound collection unit array relative to the user sound source and initial position data of the sound collection unit array line of the sound collection unit array relative to the user sound source, wherein the initial position data include initial coordinate data of the reference sound collection unit and initial angle data of the sound collection unit array line. The step of correcting DOA of the sound collection unit array according to the position data variations further includes computing angle of direction (also referred as DOA) between current sound wave direction of the user sound source and a preset normal of the sound collection unit array line.

When the relative position between the user sound source and the sound collection unit changes, a new angle of arrival between the changed user sound source and a preset normal of the sound collection unit array line can be determined according to position variation data provided by the gyroscope, accordingly DOA after change is determined and a new wave beam is formed, which causes DOA of the microphone array to point to the user sound source, thus acquired sound signals are mainly speech signals from the user sound source.

In the above technical solution, preferably, a coordinate system is established with the user sound source as the coordinate origin, and the angle of arrival is determined according to the following equation:

$$cos ( {θ}_{i + 1} ) = \frac{\begin{matrix}( {x}_{ci} + Δ {x}_{ci} ) cos ( {α}_{i} + Δ {α}_{i} ) + \\ ( {y}_{ci} + Δ {y}_{ci} ) cos ( {β}_{i} + {Δβ}_{i} ) + \\ ( {z}_{ci} + Δ {z}_{ci} ) cos ( {γ}_{i} + {Δγ}_{i} )\end{matrix}}{\sqrt{( {( {x}_{ci} + Δ {x}_{ci} )}^{2} + {( {y}_{ci} + Δ {y}_{ci} )}^{2} + {( {z}_{ci} + Δ {z}_{ci} )}^{2} )}}$$

Wherein, θᵢ₊₁ is the angle of arrival, (x_{ci}, y_{ci}, z_{ci}) is initial coordinate data of the reference sound collection unit in the coordinate system, (αᵢ, βᵢ, γᵢ) is initial angle data of the sound collection unit array line in the coordinate system, (Δx_{ci}, Δy_{ci}, Δz_{ci}) is a displacement variation of the reference sound collection unit in the coordinate system, and (Δαᵢ, Δβᵢ, Δγᵢ) is an angle variation of the sound collection unit array line in the coordinate system.

Through the above simple computing formulation, real-time DOA of the microphone array relative to the user sound source can be determined. As the computing formulation is simple, computing complexity can be greatly reduced, and accordingly DOA estimation time is reduced.

In the above technical solution, preferably, acquiring initial position data of the reference sound collection unit relative to the user sound source and initial position data of the sound collection unit array line relative to the user sound source by the use of an automatic searching method for DOA can be included.

By means of the technical solution, the initial position data c₀ of the reference sound collection unit relative to the user sound source and the initial position data v₀ of the sound collection unit array line relative to the user sound source are determined by the use of the automatic searching method for DOA, so as to determine initial DOA. That is, the initial position data c₀ ((x_{ci}, y_{ci}, z_{ci})) of the reference sound collection unit relative to the user sound source and the initial position data v₀((αᵢ, βᵢ, γᵢ)) of the sound collection unit array line relative to the user sound source are acquired by the use of the automatic searching method for DOA. Computing DOA by the use of the automatic searching method for DOA automatically starts when the user of the mobile phone begins to speech after a communication for conversation is established. Generally, DOA estimation methods based on signals received by a microphone array include conventional methods (including the spectrum estimation method, the linear prediction method, and so on), subspace methods (including the multiple signal classification method, the rotational invariance subspace method), the maximum likelihood method, and so on. All of these methods are basic DOA estimation methods, and are illustrated in related documents of array signal processing. Each of these methods has its advantages and disadvantages. For example, conventional methods may be simple, but it needs lots of microphone arrays to obtain speech effect having high resolution, furthermore, DOA estimation of conventional methods is less accurate comparing to the latter two types of methods. For mobile phones having small size arrays, apparently, these types of methods are not appropriate. The sub-space method and the maximum likelihood method can better estimate DOA, but computational work is very great. For mobile phones which require high real-time performance, all of these methods cannot satisfy requirements of real-time estimation of mobile phones. However, in order to determine initial DOA of the microphone array when a communication for conversation is established, the subspace method or the maximum likelihood method can be used to estimate DOA once when a communication for conversation is established. The maximum likelihood method is the best choice, as it is the optimal method. Although computation work of the maximum likelihood method is greatest, computing once at the initial stage cannot bring great speech delay. Based on the accurate DOA provided by the maximum likelihood method, real-time DOA can be corrected according to direction information provided by the gyroscope.

When the relative position of the reference sound unit and the user sound source changes, DOA is corrected based on variations provided by the gyroscope so as to cause DOA to always point to the user sound source, thus the noise reduction purpose can be achieved. Therefore, in the present disclosure, the automatic searching method for DOA is only applied at the time of acquiring initial position data. For subsequent estimation for self-adaptive DOA, DOA can be estimated just according to position data variations provided by the gyroscope. However, in the pertinent art, only the automatic searching method for DOA is adopted. As the automatic searching method for DOA is complex, a good real-time performance for the whole process cannot be acquired. However, in the present disclosure, the automatic searching method for DOA is only used at the time of acquiring initial position data, a good real-time performance can be acquired, and the processing rate is also greatly enhanced.

According to another aspect of the present disclosure, a speech processing apparatus is further provided. The speech processing apparatus includes an acquiring unit configured to obtain position data variations of a sound collection unit array on a terminal relative to a user sound source, a correcting unit configured to correct direction of arrival (DOA) of the sound collection unit array according to the position data variations, and a processing unit configured to perform filter processing on sound signals acquired by the sound collection unit.

The sound collection unit array signal processing method is a space-time signal processing method. Speech signals and various noise signals received by the sound collection unit are from different spatial orientations, thus if spatial orientation information is taken into consideration, signal processing ability may be greatly enhanced. The noise reduction solution based on a multiple sound collection unit array is that the sound collection unit array is expected to extract speech signals from the user sound source, and ignore noise signals from other directions, thereby achieving the purpose of noise reduction.

More particularly, the sound collection unit array is to form a wave beam in a space which points to the direction of the user sound source and can filter sound from other directions. The beam forming depends on the position of the sound collection unit array relative to the user sound source. By means of the technical solution, DOA of the sound collection unit array is corrected based on the acquired position data variations of the sound collection unit array of the terminal relative to the user sound source. No matter how the position of the terminal relative to the user sound source changes, sound signals from the direction of the user sound source can be always extracted, such that the noise reduction purpose can be achieved, that is, certain parameters of the noise reduction algorithm can be adjusted self-adaptively at any time with random changes in postures of a user during a communication process, thereby achieving the best noise reduction effect.

In the above technical solution, preferably, the acquiring unit is a gyroscope and configured for acquiring position data variations of the sound collection unit array. Wherein, the position data variations include a displacement variation of a reference sound collection unit and an angle variation of the sound collection unit array line.

By means of the technical solution, during the use of a terminal such as a mobile phone, the relative position of the user sound source and the sound collection unit changes randomly. Presently, most mobile phones include a gyroscope. The gyroscope can provide accurate information of acceleration speed and angle variation, thus in the present disclosure the gyroscope is used to obtain the position data variations of the sound collection unit array, and accurate position data variations can be acquired. Also, existing hardware devices of the terminal can be fully utilized, and there is no need to add additional hardware devices, thus noise reduction effect can be improved, and meanwhile hardware cost is reduced.

In the above technical solution, preferably, the correcting unit includes an initial position detecting unit configured to obtain initial position data of the reference sound collection unit of the sound collection unit array relative to the user sound source and initial position data of the sound collection unit array line of the sound collection unit array relative to the user sound source, wherein the initial position data include initial coordinate data of the reference sound collection unit and initial angle data of the sound collection unit array line. The correcting unit further includes a DOA computing unit configured to compute an angle of arrival between current sound wave direction of the user sound source and a preset normal of the sound collection unit array line to determine DOA of the sound collection unit array according to the angle of arrival.

When the relative position between the user sound source and the sound collection unit changes, a new angle of arrival between the user sound source and the preset normal of the sound collection unit array line after change can be determined according to the position variation data provided by the gyroscope, accordingly DOA after change is determined and a new wave beam is formed, which causes DOA of the microphone array to point to the user sound source, thus acquired sound signals are mainly speech signals from the user sound source.

In the above technical solution, preferably, a coordinate system is established with the user sound source as the coordinate origin, and the angle of arrival is determined according to the following equation:

$$cos ( {θ}_{i + 1} ) = \frac{\begin{matrix}( {x}_{ci} + Δ {x}_{ci} ) cos ( {α}_{i} + Δ {α}_{i} ) + \\ ( {y}_{ci} + Δ {y}_{ci} ) cos ( {β}_{i} + {Δβ}_{i} ) + \\ ( {z}_{ci} + Δ {z}_{ci} ) cos ( {γ}_{i} + {Δγ}_{i} )\end{matrix}}{\sqrt{( {( {x}_{ci} + Δ {x}_{ci} )}^{2} + {( {y}_{ci} + Δ {y}_{ci} )}^{2} + {( {z}_{ci} + Δ {z}_{ci} )}^{2} )}}$$

Wherein, θᵢ₊₁ is the angle of arrival, (x_{ci}, y_{ci}, z_{ci}) is initial coordinate data of the reference sound collection unit in the coordinate system, (αᵢ, βᵢ, γᵢ) is initial angle data of the sound collection unit array line in the coordinate system, (Δx_{ci}, Δy_{ci}, Δz_{ci}) is a displacement variation of the reference sound collection unit in the coordinate system, and (Δαᵢ, Δβᵢ, Δγᵢ) is an angle variation of the sound collection unit array line in the coordinate system.

Through the above simple computing formulation, real-time DOA of the microphone array relative to the user sound source can be determined. As the computing formulation is simple, computing complexity can be greatly reduced, and accordingly DOA estimation time is reduced.

In the above technical solution, preferably, the initial position detection unit obtains initial position data of the reference sound collection unit relative to the user sound source and initial position data of the sound collection unit array line relative to the user sound source by the use of an automatic searching method for DOA.

The initial position data c₀ of the reference sound collection unit relative to the user sound source and the initial position data v₀ of the sound collection unit array line relative to the user sound source are determined by the use of the automatic searching method for DOA to determine initial DOA. That is, the initial position data c₀ ((x_{ci}, y_{ci}, z_{ci})) of the reference sound collection unit relative to the user sound source and the initial position data v₀((αᵢ, βᵢ, γᵢ)) of the sound collection unit array line relative to the user sound source are acquired by the use of the automatic searching method for DOA. When the relative position of the reference sound collection unit and the user sound source changes, DOA is corrected based on variations provided by the gyroscope so as to cause DOA to always point to the user sound source, thus the noise reduction purpose can be achieved. Therefore, in the present disclosure, the automatic searching method for DOA is only used at the time of acquiring initial position data. For subsequent estimation for self-adaptive DOA, DOA can be estimated just according to position data variations provided by the gyroscope. However, in the pertinent art, only the automatic searching method for DOA is adopted. As the automatic searching method for DOA is complex, a good real-time performance for the whole process cannot be acquired. However, in the present disclosure, the automatic searching method for DOA is only used at the time of acquiring initial position data, a good real-time performance can be acquired, and the processing rate is also greatly enhanced.

According to another aspect of the present disclosure, a program product stored in a non-volatile machine readable medium for speech processing is provided. The program product includes machine executable instructions configured to enable the computing system to execute the following steps: acquiring position data variations of a sound collection unit array of a terminal relative to a user sound source, and correcting direction of arrival (DOA) of the sound collection unit array according to the position data variations.

According to another aspect of the present disclosure, a non-volatile machine readable medium is further provided. The medium stores a program product for speech processing. The program product includes machine executable instructions configured to enable the computing system to execute the following steps: acquiring position data variations of a sound collection unit array of a terminal relative to a user sound source, and correcting direction of arrival (DOA) of the sound collection unit array according to the position data variations.

According to a further aspect of the present disclosure, a machine readable program is provided, and the program can enable the machine to execute any of the speech processing methods provided by all the above technical solutions.

According to a further aspect of the present disclosure, a storage medium storing a machine readable program is further provided. Wherein, the machine readable program can enable the machine to execute any of the speech processing methods provided by all the above technical solutions.

By means of displacement and orientation variation information generated by changes in postures of the mobile phone during a communication process and provided by the gyroscope, the present disclosure provides a better noise reduction effect to the mobile phone equipped with a multiple microphone array. Generally speaking, a noise reduction functional module based on a multiple microphone array has a great requirement for hardware of the mobile phone, as a high computing ability is needed. Particularly, DOA estimation before beam forming is very complex. The method of using orientation variation information of the mobile phone provided by the gyroscope in the present disclosure can accurately and quickly compute DOA. What needed is to compute a mathematical equation, without any complex iteration or estimation algorithms, which causes the microphone array to self-adaptively point to the direction of the sound source-mouth at any time, thereby enhancing the noise reduction effect of the microphone array.

### BRIEF DESCRIPTION OF THE DRAWINGS

FIG. 1 shows position arrangement of double microphones of a double microphone terminal.

FIG. 2 shows position arrangement of three microphones of a three microphone terminal.

FIG. 3 is a schematic view of a speech processing method in accordance with an example implementation of the present disclosure.

FIG. 4 is a flow chart of an implementation of multiple microphone array noise reduction in accordance with an example implementation of the present disclosure.

FIG. 5 is a block diagram of a speech processing apparatus in accordance with an example implementation of the present disclosure.

FIG. 6 is a schematic view of beam forming of a three microphone array mobile phone.

FIG. 7 is a schematic view of a sound receiving model of a microphone array.

FIG. 8 is a schematic view of implementation principle of a delayed-add beamformer.

FIG. 9 is a schematic view of implementation principle of a delayed-add beamformer based on Wiener filtering.

FIG. 10 is a geometry schematic view based on variations of spatial position and direction of a microphone array line of a mobile phone.

### DETAILED DESCRIPTION

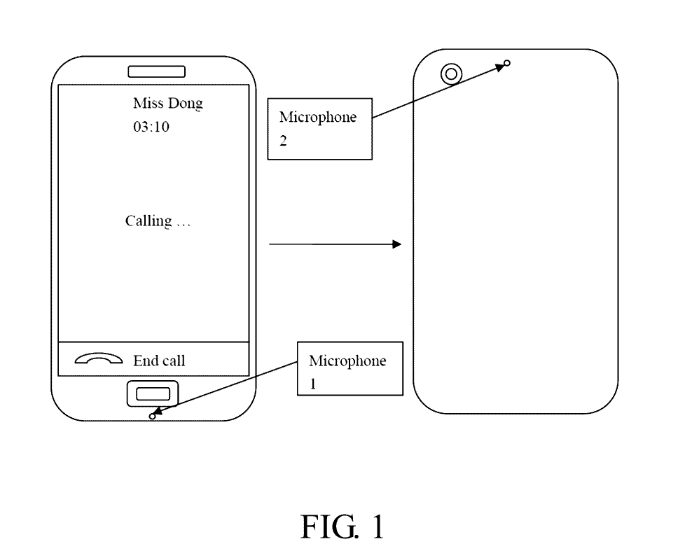

To improve quality of voice communication of mobile phones, many mobile phone manufacturers expect to improve quality of voice communication by increasing the number of microphones. Presently, multiple microphone terminals mainly include two microphone terminals and three microphone terminals (not shown). The two microphone terminal is shown in FIG. 1. However, regardless of the terminal is the two microphone terminal or the three microphone terminal, typically only one microphone is used to collect user's sound signals (the microphone 1 shown in FIG. 1), and other microphones are mainly used to collect noise signals (the microphone 2 shown in FIG. 1), and then a proper self-adaptive algorithm is selected to remove noise signals collected by the microphone 2 from signals collected by the microphone 1, which makes output voice be clear.

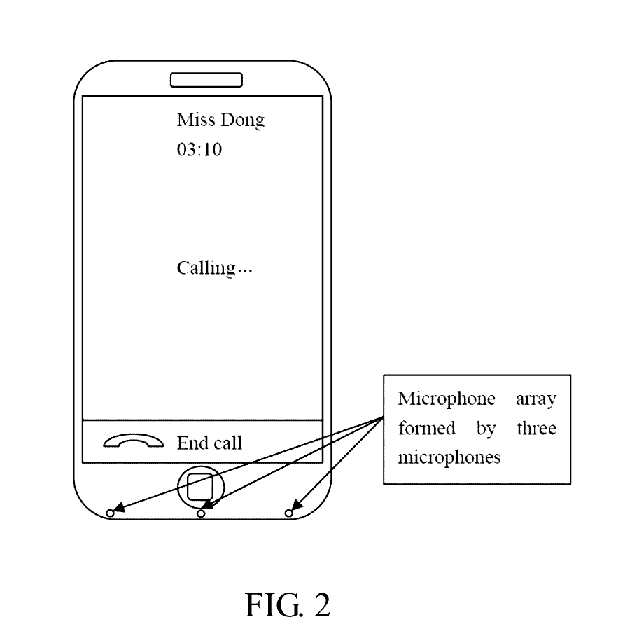

Different from the above noise reduction solutions, recently, the speech noise reduction technology based on multiple microphones array is taken into consideration by some mobile phone manufactures to perform noise reduction processing on collected speech signals with noise in a communication process, so as to obtain pure speech signals. The technology is realized by embedding multiple microphones into the mobile phone. Generally, two microphones, three microphones, or four microphones are installed in the bottom of the mobile phone, and arranged side by side (shown in FIG. 2). Each two adjacent microphones are spaced by a certain distance to form a microphone array. Then filter processing is performed on signals collected by multiple microphones through an array signal processing method, so as to achieve the purpose of noise reduction. Comparing to the self-adaptive noise reduction technology, the solution of performing noise reduction processing on array signals received by multiple microphones is more advanced and better adapted.

The multiple microphone array signal processing method is a modern signal processing method, and is also a time and spatial domain signal processing technology. The algorithm considers not only signal variations with changes of time, but also signal variations in a space, so computing is very complex. As a communication process of the mobile phone is a real-time process, it is hoped that noise reduction processing can be quickly performed on received speech signals when the multiple microphone array signal processing algorithm is used to reduce noise, so as to reduce delay to the greatest extend. However, the user of the mobile phone often changes postures during a communication process, thus distance and direction between the mobile phone and the user sound source change, which causes spatial characteristic information of received signals changes, and these changes are random and cannot be predicted. Therefore, under the condition of that spatial information of signals changes at any time, if the adopted noise reduction algorithm based on array signal processing cannot correct some parameters relative to signal orientation at any time, the noise reduction effect will be reduced, that is, the best noise reduction effect cannot be realized in the direction of variation. If the noise reduction algorithm is set to change quickly with the change of environment, great computing work is needed, which will bring great challenge to the computing ability of hardware of the mobile phone, and can also increase power consumption. Thus, applying the noise reduction solution based on the multiple microphone array signal processing to the mobile phone is impractical, and cannot bring good experience to users, either the noise reduction effect is not good, or a great source of the mobile phone is consumed.

To understand the above-mentioned purposes, features and advantages of the present disclosure more clearly, the present disclosure will be further described in detail below in combination with the accompanying drawings and the specific implementations. It should be noted that, the implementations of the present application and the features in the implementations may be combined with one another without conflicts.

Many specific details will be described below for sufficiently understanding the present disclosure. However, the present disclosure may also be implemented by adopting other manners different from those described herein. Accordingly, the protection scope of the present disclosure is not limited by the specific implementations disclosed below.

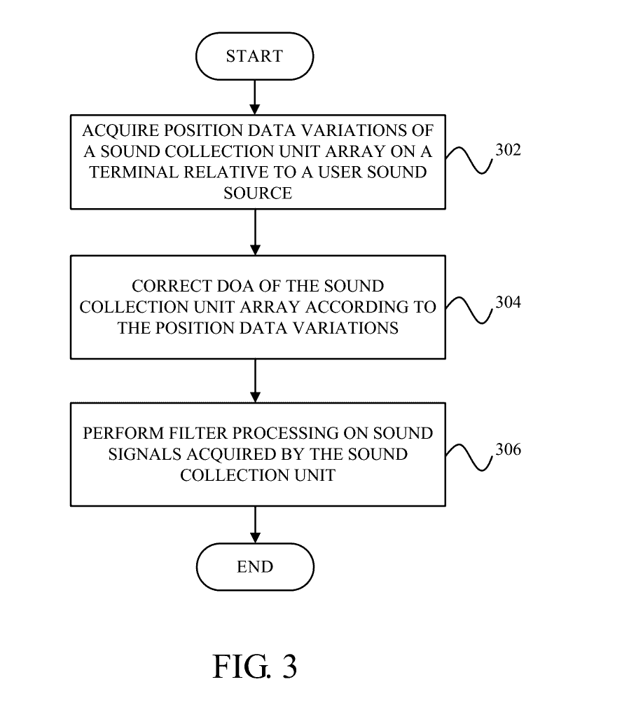

FIG. 3 is a schematic view of a speech processing method in accordance with an implementation of the present disclosure.

As shown in FIG. 3, the speech processing method in accordance with an example implementation of the present disclosure may include the following steps: step 302 of acquiring position data variations of a sound collection unit array on a terminal relative to a user sound source, step 304 of correcting direction of arrival (DOA) of the sound collection unit array according to the position data variations, and step 306 of performing filter processing on sound signals acquired by the sound collection unit.

The sound collection unit array signal processing method is a space-time signal processing method. Speech signals and various noise signals received by the sound collection unit are from different spatial orientations, thus if spatial orientation information is taken into consideration, signal processing ability may be greatly enhanced. The noise reduction solution based on a multiple sound collection unit array is that the sound collection unit array is expected to extract speech signals from the user sound source, and perform filter processing on the speech signals to reduce noise.

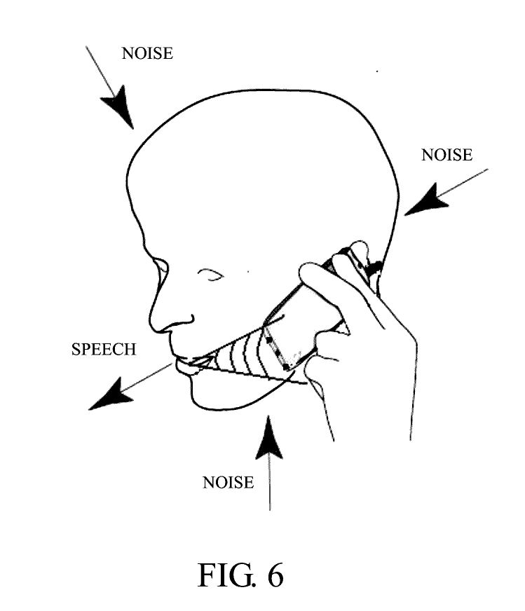

More particularly, the sound collection unit array is to form a beam in space (shown in FIG. 6) which points to the direction of the user sound source and can filter sound from other directions. The beam forming depends on the position of the sound collection unit array relative to the user sound source. By means of the technical solution, DOA of the sound collection unit array is corrected based on the acquired position data variation of the sound collection unit array of the terminal relative to the user sound source. No matter how the position of the terminal relative to the user sound source changes, sound signals from the direction of the user sound source can be always extracted, such that the noise reduction purpose can be achieved, that is, certain parameters of the noise reduction algorithm can be adjusted self-adaptively at any time with random changes in postures of a user during a communication process, and filter processing is performed on sound signals acquired by the sound collection unit, thereby achieving the best noise reduction effect.

In the above technical solution, preferably, position data variations of the sound collection unit array are acquired by the use of a gyroscope of the terminal. Wherein, the position data variations include a displacement variation of a reference sound collection unit and an angle variation of the sound collection unit array line.

In the above technical solution, preferably, the step of correcting DOA of the sound collection unit array according to the position data variations includes acquiring initial position data of the reference sound collection unit of the sound collection unit array relative to the user sound source and initial position data of the sound collection unit array line of the sound collection unit array relative to the user sound source, wherein the initial position data include initial coordinate data of the reference sound collection unit and initial angle data of the sound collection unit array line. The step of correcting DOA of the sound collection unit array according to the position data variations further includes computing an angle of arrival between current sound wave direction of the user sound source and a preset normal of the sound collection unit array line (that is, DOA is determined).

In the above technical solution, preferably, a coordinate system is established with the user sound source as the coordinate origin, and the angle of arrival is determined according to the following equation:

$$cos ( {θ}_{i + 1} ) = \frac{\begin{matrix}( {x}_{ci} + Δ {x}_{ci} ) cos ( {α}_{i} + Δ {α}_{i} ) + \\ ( {y}_{ci} + Δ {y}_{ci} ) cos ( {β}_{i} + {Δβ}_{i} ) + \\ ( {z}_{ci} + Δ {z}_{ci} ) cos ( {γ}_{i} + {Δγ}_{i} )\end{matrix}}{\sqrt{( {( {x}_{ci} + Δ {x}_{ci} )}^{2} + {( {y}_{ci} + Δ {y}_{ci} )}^{2} + {( {z}_{ci} + Δ {z}_{ci} )}^{2} )}}$$

Wherein, θᵢ₊₁ is the angle of arrival, (x_{ci}, y_{ci}, z_{ci}) is initial coordinate data of the reference sound collection unit in the coordinate system, (αᵢ, βᵢ, γᵢ) is initial angle data of the sound collection unit array line in the coordinate system, (Δx_{ci}, Δy_{ci}, Δz_{ci}) is a displacement variation of the reference sound collection unit in the coordinate system, and (Δαᵢ, Δβᵢ, Δγᵢ) is an angle variation of the sound collection unit array line in the coordinate system.

Through the above simple computing formulation, real-time DOA of the microphone array relative to the user sound source can be determined. As the computing formulation is simple, computing complexity can be greatly reduced, and accordingly DOA estimation time is reduced.

In the above technical solution, preferably, acquiring initial position data of the reference sound collection unit relative to the user sound source and initial position data of the sound collection unit array line relative to the user sound source by the use of an automatic searching method for DOA can be included.

The initial position data c₀ of the reference sound collection unit relative to the user sound source and the initial position data v₀ of the sound collection unit array line relative to the user sound source are determined by the use of the automatic searching method for DOA to determine initial DOA. That is, the initial position data c₀ ((x_{ci}, y_{ci}, z_{ci})) of the reference sound collection unit relative to the user sound source and the initial position data v₀ ((αᵢ, βᵢ, γᵢ)) of the sound collection unit array line relative to the user sound source are acquired by the use of the automatic searching method for DOA. Computing DOA by the use of the automatic searching method for DOA automatically starts when the user of the mobile phone begins to speech after a communication for conversation established. Generally, DOA estimation methods based on signals received by the microphone array include conventional methods (including the spectrum estimation method, the linear prediction method, and so on), subspace methods (including the multiple signal classification method, the rotational invariance subspace method), the maximum likelihood method, and so on. All of these methods are basic DOA estimation methods, and are illustrated in related documents of array signal processing. Each of these methods has its advantages and disadvantages. For example, conventional methods may be simple, but it needs lots of microphone arrays to achieve speech effect having high resolution, furthermore, DOA estimation of conventional methods is less accurate comparing to the latter two types of methods. For the mobile phone having this small size array, apparently, these types of methods are not appropriate. The sub-space method and the maximum likelihood method can better estimate DOA, but computational work is very great. For mobile phones which require high real-time performance, all of these methods cannot satisfy requirements of real-time estimation of mobile phones. However, in order to determine initial DOA of the microphone array when a communication for conversation is established, the subspace method or the maximum likelihood method can be used to estimate DOA once when a communication for conversation is established. The maximum likelihood method is the best choice, as it is the optimal method. Although computation work of the maximum likelihood method is greatest, computing once at the initial stage cannot bring great speech delay. Based on the accurate DOA provided by the maximum likelihood method, real-time DOA can be corrected according to direction information provided by the gyroscope.

When the relative position of the reference sound collection unit and the user sound source changes, DOA is corrected based on variations provided by the gyroscope so as to cause DOA to always point to the direction of the user sound source, thus the noise reduction purpose can be achieved. Therefore, in the present disclosure, the automatic searching method for DOA is only used at the time of acquiring initial position data. For subsequent estimation for self-adaptive DOA, DOA can be estimated just according to position data variations provided by the gyroscope. However, in the pertinent art, only the automatic searching method for DOA is adopted. As the automatic searching method for DOA is complex, a good real-time performance for the whole process cannot be acquired. However, in the present disclosure, the automatic searching method for DOA is only used at the time of acquiring initial position data, a good real-time performance can be acquired, and the processing rate is also greatly enhanced.

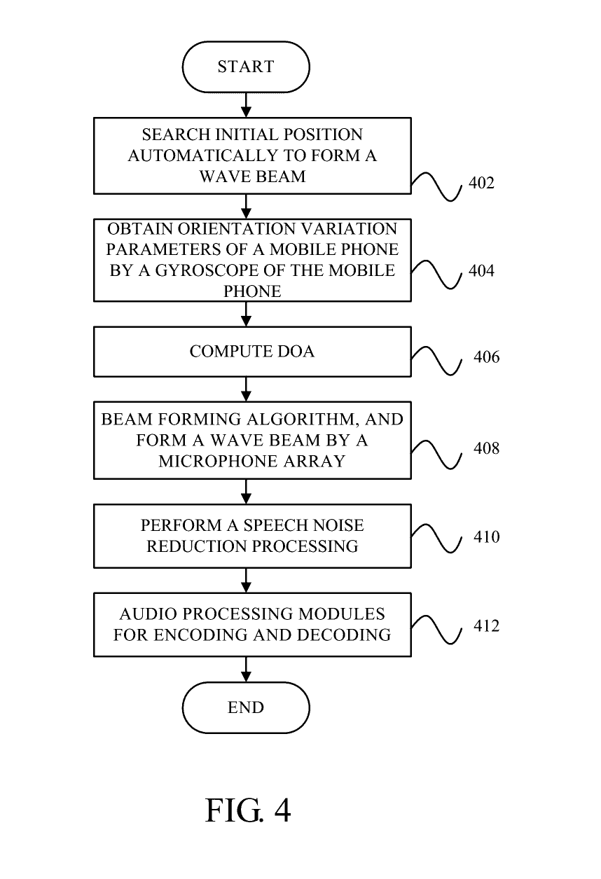

FIG. 4 is a flow chart of an implementation of multiple microphone array noise reduction by the use of gyroscope information in accordance with an example implementation of the present disclosure. The implementation can be performed by software or hardware, or a combination of both.

As shown in FIG. 4, the implementation process of multiple microphone array noise reduction by the use of gyroscope information includes the following steps.

Step 402, searching initial position automatically to form a wave beam. The automatic searching method for DOA is used to search initial positions of the microphone array and the user sound source to form a wave beam.

Computing DOA by the use of the automatic searching method for DOA automatically starts when the user of the mobile phone begins to speech after a communication for conversation being established. Generally, DOA estimation methods based on signals received by the microphone array include conventional methods (including the spectrum estimation method, the linear prediction method, and so on), subspace methods (including the multiple signal classification method, the rotational invariance subspace method), the maximum likelihood method, and so on. All of these methods are basic DOA estimation methods, and are illustrated in related documents of array signal processing. Each of these methods has its advantages and disadvantages. For example, conventional methods may be simple, but it needs lots of microphone arrays to achieve speech effect having high resolution, furthermore, DOA estimation of conventional methods is less accurate comparing to the latter two types of methods. For the mobile phone having this small size array, apparently, these types of methods are not appropriate. The sub-space method and the maximum likelihood method can better estimate DOA, but computational work is very great. For mobile phones which require high real-time performance, all of these methods cannot satisfy requirements of real-time estimation of mobile phones. However, in order to determine DOA of the microphone array when a communication for conversation is established, the subspace method or the maximum likelihood method can be used to estimate DOA once when a communication for conversation is established. The maximum likelihood method is the best choice, as it is the optimal method. Although computation work of the maximum likelihood method is greatest, computing once at the initial stage cannot bring great speech delay. Based on the accurate DOA provided by the maximum likelihood method, real-time DOA can be corrected according to direction information provided by the gyroscope. That is, the initial position data c₀ ((x_{ci}, y_{ci}, z_{ci})) of the reference sound collection unit relative to the user sound source and the initial position data v₀((αᵢ, βᵢ, γᵢ)) of the sound collection unit array line relative to the user sound source are acquired by the use of the automatic searching method for DOA.

Step 404, acquiring orientation variation parameters of the mobile phone by the gyroscope of the mobile phone. When orientation of the mobile phone changes, the gyroscope obtains position variation data.

Step 406, computing DOA. DOA after change is determined according to the initial position information and the orientation variation.

Step 408, inputting DOA data into DOA forming algorithm, and forming a wave beam by the microphone array.

Step 410, performing speech noise reduction processing. Filter processing is performed on sound signals acquired by the sound collection unit, that is, noise reduction processing is performed on speech signals collected by the wave beam.

Step 412, performing encoding and decoding processing by audio processing modules. The encoding and decoding processing is performed on the speech signals processed by noise reduction processing to output the processed speech signals.

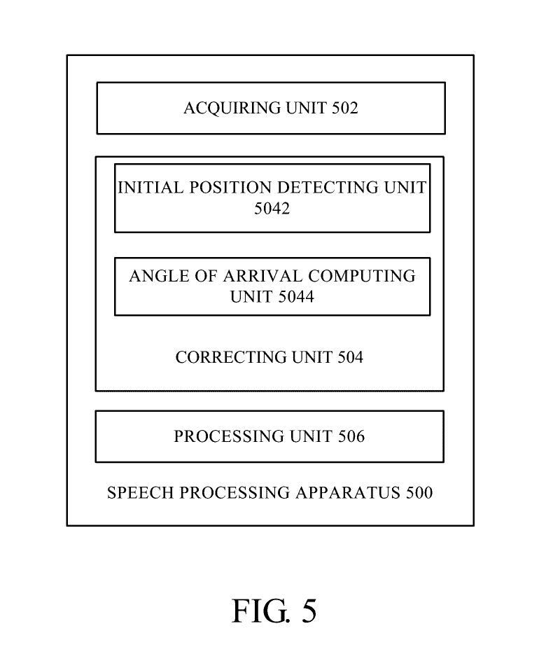

FIG. 5 is a terminal block diagram of a speech processing apparatus in accordance with another example implementation of the present disclosure.

As shown in FIG. 5, a speech processing apparatus 500 according to an example implementation of the present disclosure includes an acquiring unit 502 configured to obtain position data variations of a sound collection unit array of a terminal relative to a user sound source, a correcting unit 504 configured to correct direction of arrival (DOA) of the sound collection unit array according to the position data variations, and a processing unit 506 configured to perform filter processing on sound signals acquired by the sound collection unit. Various units of the speech processing apparatus 500 may be realized by computer programs which stored in a storage unit of the speech processing apparatus 500, and can be executed by one or more processors of the speech processing apparatus 500 to perform corresponding functions, or various units of the speech processing apparatus 500 may be integrated in one processor or distributed different processors of the speech processing apparatus 500.

The sound collection unit array signal processing method is a space-time signal processing method. Speech signals and various noise signals received by the sound collection unit are from different spatial orientations, thus if spatial orientation information is taken into consideration, signal processing ability may be greatly enhanced. The noise reduction solution based on a multiple sound collection unit array is that the sound collection unit array is expected to extract speech signals from the user sound source, and perform filter processing on the speech signals to reduce noise.

More particularly, the sound collection unit array is to form a wave beam in space (shown in FIG. 6) which points to the direction of the user sound source and can filter sound from other directions. The wave beam forming depends on the position of the sound collection unit array relative to the user sound source. By means of the technical solution, DOA of the sound collection unit array is corrected based on the acquired position data variation of the sound collection unit array of the terminal relative to the user sound source. No matter how the position of the terminal relative to the user sound source changes, sound signals from the direction of the user sound source can be always extracted, such that the noise reduction purpose can be achieved, that is, certain parameters of the noise reduction algorithm can be adjusted self-adaptively at any time with random changes in postures of a user during a communication process, thereby achieving the best noise reduction effect.

In the above technical solution, preferably, the acquiring unit is a gyroscope and is used to obtain position data variations of the sound collection unit array. Wherein, the position data variations include a displacement variation of a reference sound collection unit and an angle variation of the sound collection unit array line.

During the use of a terminal such as a mobile phone, the relative position of the user sound source and the sound collection unit changes randomly. Presently, most mobile phones include a gyroscope. The gyroscope can provide accurate information of acceleration speed and angle variation, thus in the present disclosure, the gyroscope is used to obtain position data variations of the sound collection unit array, and accurate position data variations can be acquired. Also, existing hardware devices of the terminal can be fully utilized, and there is no need to add additional hardware devices, thus noise reduction effect can be improved, and meanwhile hardware cost is reduced.

In the above technical solution, preferably, the correcting unit 504 includes an initial position detecting unit 5042 configured to obtain initial position data of the reference sound collection unit of the sound collection unit array relative to the user sound source and initial position data of the sound collection unit array line of the sound collection unit array relative to the user sound source, wherein the initial position data include initial coordinate data of the reference sound collection unit and initial angle data of the sound collection unit array line. The correcting unit 504 further includes an angle of arrival computing unit 5044 configured to compute an angle of arrival between current sound wave direction of the user sound source and a preset normal of the sound collection unit array line to determine DOA of the sound collection unit array according to the angle of arrival.

When the relative position between the user sound source and the sound collection unit changes, a new angle of arrival between the user sound source and the preset normal of the sound collection unit array line after change can be determined according to the position variation data provided by the gyroscope, accordingly DOA after change is determined and a new wave beam is formed, which causes DOA of the microphone array to point to the user sound source, thus acquired sound signals are mainly speech signals from the user sound source.

In the above technical solution, preferably, the angle of arrival computing unit forms a coordinate system with the user sound source as the coordinate origin, and computes the angle of arrival according to the following equation:

$$cos ( {θ}_{i + 1} ) = \frac{\begin{matrix}( {x}_{ci} + Δ {x}_{ci} ) cos ( {α}_{i} + Δ {α}_{i} ) + \\ ( {y}_{ci} + Δ {y}_{ci} ) cos ( {β}_{i} + {Δβ}_{i} ) + \\ ( {z}_{ci} + Δ {z}_{ci} ) cos ( {γ}_{i} + {Δγ}_{i} )\end{matrix}}{\sqrt{( {( {x}_{ci} + Δ {x}_{ci} )}^{2} + {( {y}_{ci} + Δ {y}_{ci} )}^{2} + {( {z}_{ci} + Δ {z}_{ci} )}^{2} )}}$$

Wherein, θᵢ₊₁ is the angle of arrival, (x_{ci}, y_{ci}, z_{ci}) is initial coordinate data of the reference sound collection unit in the coordinate system, (αᵢ, βᵢ, γᵢ) is initial angle data of the sound collection unit array line in the coordinate system, (Δx_{ci}, Δy_{ci}, Δz_{ci}) is a displacement variation of the reference sound collection unit in the coordinate system, and (Δαᵢ, Δβᵢ, Δγᵢ) is an angle variation of the sound collection unit array line in the coordinate system. Through the above simple computing formulation, real-time DOA of the microphone array relative to the user sound source can be determined. As the computing formulation is simple, computing complexity can be greatly reduced, and accordingly DOA estimation time is reduced.

In the above technical solution, preferably, the initial position detection unit 5042 obtains initial position data of the reference sound collection unit relative to the user sound source and initial position data of the sound collection unit array line relative to the user sound source by the use of an automatic searching method for DOA

By means of the technical solution, the initial position data c₀ of the sound collection unit relative to the user sound source and the initial position data v₀ of the the sound collection unit array line are acquired by the use of automatic searching method for DOA, thus initial DOA is determined. When the relative position between the reference sound unit and the user sound source changes, DOA is corrected according to variations provided by the gyroscope, to cause DOA to always extract signals from the direction of the user sound source, thereby achieving the purpose of noise reduction.

The following will further illustrate another example implementation of the present disclosure in conjunction with FIGS. 6-10.

Different from speech noise reduction solutions based on time domain signal analysis (for example, double microphones based self-adaptive noise reduction methods, single microphone based filter noise reduction methods, and so on), the multiple microphone array signal processing method takes spatial information of signals into consideration, and is a time-space signal processing method. Speech signals and various noise signals received by the microphones are from different spatial orientations, thus when spatial orientation information is taken into consideration, signal processing performance will be greatly enhanced, especially for such applications which need to extract signals from a certain spatial orientation. The microphone array based noise reduction solution is the solution that the microphone array is expected to extract sound signals from the direction of the sound source-mouth and ignore noise signals from other directions, thereby achieving the noise reduction purpose.

More particularly, the microphone array is to form a wave beam in space which points to the direction of a mouth which generates sound, and sound from other directions is filtered. FIG. 6 is a schematic view of a wave beam of a mobile phone having a three microphone array. In this figure, three microphones (shown by black spots) are installed in the bottom of the mobile phone and form an array. The wave beam formed when the array signal processing method is used to perform noise reduction process is shown in the figure. The ripple range is an ideal speech signal reception range, and it means that the microphone array can only receive sound from the user's mouth, and automatically filter interference noise from other directions.

Generally, the two main research directions of the array signal processing field are beam forming and DOA estimation. The array signal processing method for speech noise reduction is actually to process beam forming. Actually, speech noise reduction solutions for mobile phones much depend on difference between desired speech signals and noise interference signals in a space, thus presently, noise reduction applications of mobile phones based on multiple sound collection unit arrays often employ beam forming algorithms based on space reference. Certainly, there are different variations based on this kind of methods, but basic principles are similar. The following will illustrate the most basic beam forming principle based on space reference, and then illustrate shortcomings brought by applying the most basic beam forming principle based on space reference to reduce noise of mobile phones. Finally, advantages brought by the present disclosure based on orientation information provided by the gyroscope of the mobile phone are set out. In the following, microphones are used as an example to illustrate the sound collection unit.

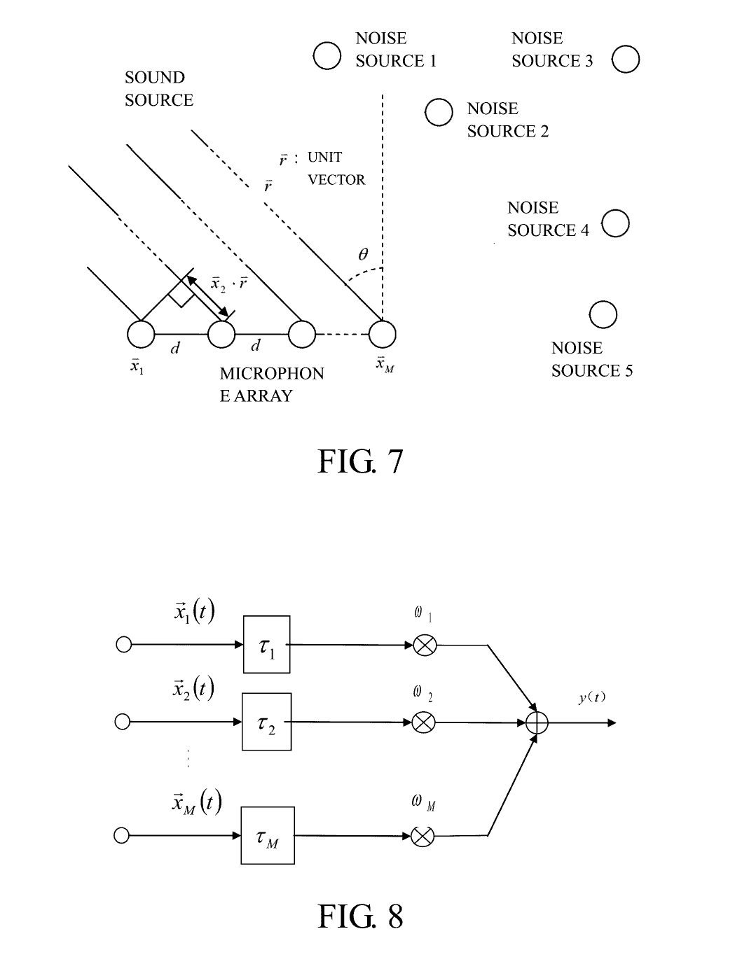

The multiple microphone array signal processing algorithm firstly involves array formulation of multiple microphones, that is, involves how to arrange the microphones. The array formulation generally includes forming a uniformly spaced or non-uniformly spaced linear array, a circle plane array, or a volume array. However, due to limitation of structure and volume of the mobile phone, the array formed on the mobile phone is generally the uniform linear array. In this array, two or three, or at most four microphones are arranged on the bottom of the mobile phone at equal spacing, to pick up various sound signals, which is shown in FIG. 7. In FIG. 7, the most bottom microphone array 714 is formed by M microphones, described as \vec{x}ᵢ (i=1, 2, . . . , M), the distance between two adjacent microphones is d, and signals from a desired sound source 702 is s(t). A number of noise sources (704, 706, 708, 710, 712) are adjacent to the microphone array, described as nⱼ(t)(j=1, 2, . . . , J), θ is the angle of arrival between the direction of the user sound source and the normal direction of a reference microphone array. The first microphone \vec{x}ᵢ is made as a reference microphone, the time delay of other microphones relative to the reference microphone is

$${τ}_{i} = - \frac{1}{c} sin ( θ ) ( m - 1 ) d ,$$

thus the direction vector of the microphone array is:

$$\begin{matrix}a ( θ ) = {[ 1 , {e}^{- j \frac{{w}_{0}}{c} dsin ( θ )} , {e}^{- j \frac{{w}_{0}}{c} 2 dsin ( θ )} , … , {e}^{- j \frac{{w}_{0}}{c} d ( M - 1 ) sin ( θ )} ]}^{T} \\ = {[ 1 , {e}^{- j \frac{2 π}{{λ}_{0}} dsin ( θ )} , {e}^{- j \frac{2 π}{{λ}_{0}} 2 dsin ( θ )} , … , {e}^{- j \frac{2 π}{{λ}_{0}} d ( M - 1 ) sin ( θ )} ]}^{T}\end{matrix} \qquad ( 1 )$$

In (1) equation, λ₀ is the wavelength. When geometry of the wavelength and the array is determined, the direction vector is only related to the spatial angle θ, thus the direction vector of the array can be recorded as α(θ), and is irrelevant to the reference point. Thus, the output of M microphones can be described as:

$$\begin{matrix}x ( t ) = [ \begin{matrix}{{x}^{->}}_{1} ( t ) \\ {{x}^{->}}_{2} ( t ) \\ ⋮ \\ {{x}^{->}}_{M} ( t )\end{matrix} ] + [ \begin{matrix}s ( t ) \\ s ( t ) {e}^{- j \frac{2 π}{{λ}_{0}} dsin ( θ )} \\ ⋮ \\ s ( t ) {e}^{- j \frac{2 π}{{λ}_{0}} ( M - 1 ) dsin ( θ )}\end{matrix} ] + [ \begin{matrix}{n}_{1} ( t ) \\ {n}_{2} ( t ) \\ ⋮ \\ {n}_{M} ( t )\end{matrix} ] \\ = a ( θ ) s ( t ) + n ( t )\end{matrix} \qquad ( 2 )$$

The above equation is the generation model of the microphone array signal x(t), the spatial angle θ is a known reference. After constructing the array model, the beam forming technology can be employed to extract desired sound source signals s(t) from pickup signals x(t) of the microphones. The method is realized by performing spatial domain filter on each microphone array signal weighting, thus the purpose of enhancing desired signals and restraining interference signals can be achieved. Furthermore, the weighting factor of each array signal can be changed self-adaptively according to change of signal environment. The microphones adopted here are omni-directional. However, after performing weighted summation processing on each array signal, reception directions of the array can be gathered to one direction, that is, a wave beam is formed. In sum, the basic principle of the beam forming is to perform weighted summation processing on each signal of the microphone array and direct the array wave beam to one direction, and realize the greatest output power of desired signals.

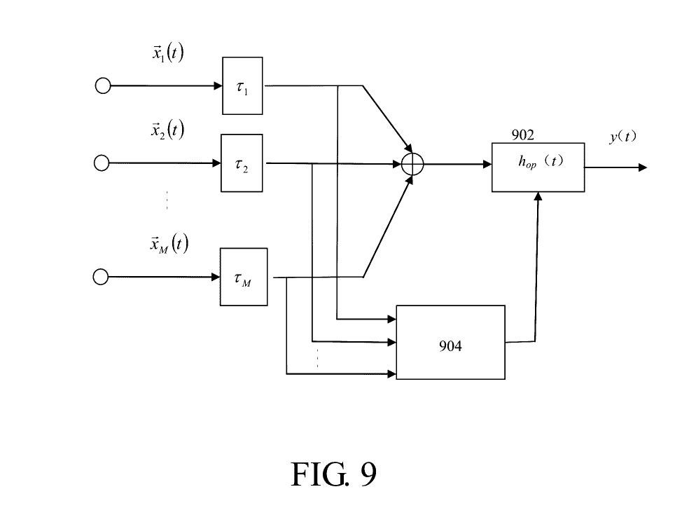

To form a directivity wave beam, firstly, some assumption for signals is made. For example, if it is assumed that each signal \vec{x}ᵢ(t) picked up by the array is irrelevant to the noise source signals nⱼ(t), and signals received by each microphone has the same statistics characteristic. Under this assumption, the specific wave beam forming solution is to add an appropriate delay compensation τᵢ to each pickup signal \vec{x}ᵢ(t), which results in synchronization of all output signals in θ direction, thus incident signal in θ direction received by the microphone array has a maximum gain, and meanwhile a weighting coefficient ωᵢ is assigned to each microphone pickup signal to perform taper processing on the wave beam formed by the array. Thus, signals from different directions have different gains, and spatial filtering effect can be achieved. By means of separating signals from different directions in space, the purpose of extracting desired speech signals and noise reduction can be achieved. Actually, there are various methods to determine the parameter ωᵢ. The basic methods include the method of employing delayed-add wave beam former and the method of employing Wiener filter based delayed-add wave beam former. The implementation processes of these two kinds of wave beam former are respectively shown in FIG. 8 and FIG. 9.

As shown in FIG. 8 and FIG. 9, the parameter τᵢ is known and its value depends on the spatial reference angle θ. For the parameter ωᵢ in FIG. 9, the parameter ωᵢ is acquired by optimization method and its value depends on θ, actually it should be recorded as ωᵢ(θ). For acquiring optimized ωᵢ(θ) to form a desired wave beam, the acquired ωᵢ(θ) can cause the output power of the wave beam to be maximum, wherein the output y(t) is:

$$y ( t ) = {\sum }_{m = 1}^{M} {ω}_{m}^{*} ( θ ) {{x}^{->}}_{m} ( t ) = {w ( θ )}^{H} x ( t ) \qquad ( 3 )$$

Wherein, w(θ)=[ω₁(θ), ω₂(θ), . . . , ω_{M}(θ)], the output power of the wave beam former is:

$$\begin{matrix}P ( w ( θ ) ) = \frac{1}{M} {\sum }_{m = 1}^{M} {\vert y ( t ) \vert}^{2} \\ = \frac{1}{M} {\sum }_{m = 1}^{M} {\vert {ω}_{m}^{*} ( θ ) {{x}^{->}}_{m} ( t ) \vert}^{2} \\ = {w ( θ )}^{H} E [ x ( t ) {x}^{H} ( t ) ] w ( θ )\end{matrix} \qquad ( 4 )$$

At this point an objective function based on P(w(θ)) can be established, and the objective function is optimized to cause the output power of the wave beam former to be maximum. The weighting coefficient w(θ) acquired during the solution process is the optimization parameter. That is, the beam wave former shown in FIG. 8 is established. The similar method is used to establish the wave beam former shown in FIG. 9, besides that a parameter estimation method 904 of the Wiener filter is used to establish the final Wiener filter 902.

The above is intended to describe the basic theory algorithm of beam forming, and it can be seen that the establishment of the wave beam former depends on the spatial reference angle θ, that is, DOA. Therefore, the parameter is important for the wave beam former and speech noise reduction effect. Generally a very accurate estimation value is needed. If there is a deviation, the final noise reduction effect will be decreased, as the wave beam does not point to the direction of the user sound source accurately and instead points to other direction, which will result in reception of some noise interference signals. Especially for a near filed wave beam forming method, as the sound source and the noise source may be near to the microphone array, a little deviation of the parameter angle θ can result in failure of noise reduction. Generally speaking, if the microphone array and the position of the desired acquired sound source are fixed, then after accurate DOA is determined, a set of fixed beam forming algorithm (the above described algorithm) can be concluded according to distance and orientation parameters of hardware settings to perform speech noise reduction process. Thus, the best noise reduction effect can be achieved at any time. However, this condition is very ideal. For actual conversation scenario, even though the position of the sound source is fixed (because the main pickup speech source in a communication process is sound of the caller, and is not external human sound and interference noise), people may change postures at any time during a communication process, and these changes cannot be predicted and tracked. That is, changes in postures during a communication process are random, which results in random changes in positions and postures of the mobile phone, and results in changes in distances and directions relative to the sound source. For the microphone array of the mobile phone, DOA can also change accordingly. Under this condition, if the parameter employed by the wave beam former still depends on the initial reference angle θ, the wave beam will not point to the sound source, and instead point to other direction, thus desired acquired sound source speech signals may be regarded as noise, and noise may be regarded as desired acquired speech, which results in failure of noise reduction and may bring bad communication effect.

To solve the above described technical problem, the wave beam formed by the microphone array of the mobile phone needs to change at any time to point to the sound source self-adaptively, thus a DOA estimation method is needed. Actually, DOA is used to position the sound source to cause subsequently formed wave beams to point the correct direction. DOA estimation methods are very complex and the computing work is very great, Furthermore, DOA change should be monitored at any time. If applying the method to the mobile phone, the chip of the mobile phone will endure a very great computing load, which will cause great power consumption. Furthermore, the complex computing processing plus the computing process of the subsequent beam forming algorithm will cause speech delay. For real-time conversation, great speech delay should be avoided. In addition, all DOA estimation methods are based on parameter estimation methods, such as the maximum likelihood estimation method, the maximum entropy estimation method, and so on, which may cause estimated DOA θ is not very accurate. However, the above mentioned wave beam former depends on an accurate reference angle θ, thus an inaccurate θ estimation will affect the forming of the wave beam former, which accordingly affect speech noise reduction effect.

Based on the above analysis, software algorithms adopting array signal processing only, which includes beam forming and DOA estimation, cannot realize speech noise reduction of the mobile phone, or cannot achieve good noise reduction effect. Therefore, other solutions should be taken into consideration.

In the present disclosure, information provided by a gyroscope is used to form a wave beam to achieve the purpose of noise reduction, which can better solve the above mentioned technical problems. Firstly, at present many mobile phones include a gyroscope and the gyroscope can provide very accurate information of movement direction, acceleration speed, and angle variation. Thus the gyroscope can be used to obtain position data variations of the sound collection unit array to determine DOA. Wherein, the position data variations include a displacement variation and an angle variation. As the gyroscope can quickly and accurately determine orientation information and does not take up system resource of the mobile phone, the above mentioned problems can be solved well. That is, the DOA estimation algorithm is replaced by the gyroscope, and DOA θ can be determined through hardware, and then the wave beam former is established, which can realize good noise reduction effect.

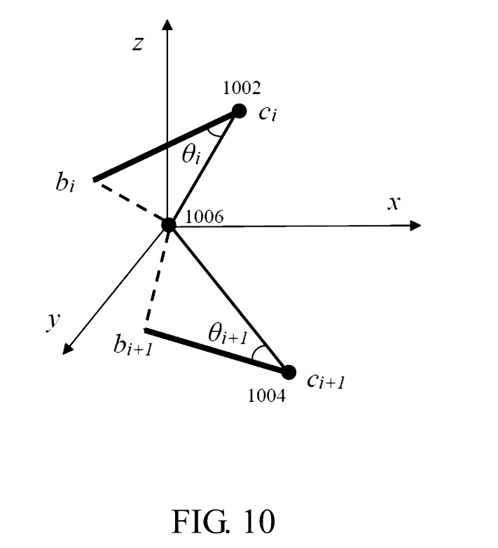

The following will illustrate how to determine DOA of the sound collection unit array through the gyroscope in conjunction with FIG. 10. Microphones are often installed on the bottom of the mobile phone equipped with a multiple microphone array, and are arranged in a uniform linear array which often includes 2˜4 microphones. FIG. 2 shows an array formed by three microphones. The three microphones at the bottom form a straight line, and the straight line and the screen of the mobile phone are in a same plane. Thus, the movement distance and rotational angle of the straight line will change with the movement or rotation of the mobile phone. The displacement and angle variation of the mobile phone will be recorded by the gyroscope, thus data determined by the gyroscope represents the position and direction variation of the microphone array, and can be used to determine DOA change of the sound source. Referring to the above illustration relating to FIG. 7, during forming a wave beam, firstly, it needs to determine a reference microphone in the microphone array, and a connection line connecting the sound source and the reference microphone is taken as direction of sound wave. In subsequent algorithm derivation, the rightmost microphone of the microphone array is always taken as the reference microphone, as dot 1002 and dot 1004 shown in FIG. 10. FIG. 10 shows a spatial coordinate system. The microphone arrays represented by two black thick lines change with movement and rotation of the mobile phone. The coordinate system is determined according to direction and distance relationship between the sound source 1006 and the microphone array during a communication process to facilitate analysis of algorithms. In this figure, the sound source 1006 is taken as the coordinate origin of a three-dimension space, and it indicates that the position of the sound source always represents the origin. The microphone array changes randomly in this space, and variation of distance and orientation between the microphones and the sound source 1006 can be indicated by relationship variation between the dark thick line and the origin in the coordinate system. In this figure, the dark thick line represents the straight line formed by the microphone array, and the length is d. The two dark thick straight lines represent variation of the microphone array line after the orientation of the mobile phone is changed by the user in a communication process. It is assumed that the upper line represents the position of the microphone array line before change, and the lower line represents the position of the microphone array line after change.

For the microphone array before change, DOA (that is, the above described reference direction angle) is θᵢ, the position of the reference microphone is cᵢ, and the spatial coordinate is set to be cᵢ=[x_{ci}, y_{ci}, z_{ci}]. The position of the microphone of the other terminal of the microphone array is set to be bᵢ, and the spatial coordinate is set to be b=[x_{bi}, y_{bi}, z_{bi}], and meanwhile it is assumed that the orientation coordinate (that is, the angle formed by three axes) of the microphone array line is νᵢ=[αᵢ, βᵢ, γᵢ], then bᵢ can be described as follows:

bᵢ=[x_{bi},z_{bi},z_{bi}]=[x_{ci}−d cos αᵢ,y_{ci}−d cos βᵢ,z_{ci}−d cos γᵢ] (5)

Similarly, for the microphone array after change, DOA (that is, the above described reference direction angle) is θᵢ₊₁, the position of the reference microphone is cᵢ₊₁, and the spatial coordinate is set to be cᵢ₊₁=└x_{c(i+1)}, y_{c(i+1)}, z_{c(i+1)}┘. The position of the microphone of the other end of the microphone array is set to be bᵢ₊₁, and the spatial coordinate is set to be bᵢ₊₁=└k_{b(i+1)}, y_{b(i+1)}, z_{b(i+1)}┘, and meanwhile it is assumed that the orientation coordinate (that is, the angle formed by three axes) of the microphone array line is νᵢ₊₁=[αᵢ₊₁, βᵢ₊₁, γᵢ₊₁], then bᵢ₊₁ can be described as follows:

bᵢ₊₁=└k_{b(i+1)},y_{b(i+1)},z_{b(i+1)}┘=└x_{c(i+1)}−d cos αᵢ₊₁,y_{c(i+1)}−d cos βᵢ₊₁,z_{ci}−d cos γᵢ₊₁┘ (6)

It is assumed that variations of position and direction of the microphone array line bring variations of angle and displacement. The orientation is changed from νᵢ to νᵢ₊₁, and the variation vector is recorded as:

Δνᵢ=[Δαᵢ,Δβᵢ,Δγᵢ]=[αᵢ₊₁−αᵢ,βᵢ₊₁−βᵢ,γᵢ₊₁−γᵢ] (7)

The position of the reference microphone is changed from cᵢ to cᵢ₊₁, and the displacement vector is recorded as:

Δcᵢ=[Δx_{ci},Δy_{ci},Δz_{ci}]=└x_{c(i+1}−x_{ci},y_{c(i+1)}−y_{ci},z_{c(i+1)}−z_{ci}┘ (8)

The two vectors Δνᵢ and Δcᵢ described above can be acquired by the gyroscope of the mobile phone, and the gyroscope can provide corresponding variations in time with variations of position and direction of the mobile phone at any time.

After acquiring these known variables relating to change of the array line of the mobile phone, the following will determine θ_{i±1} according to geometry relationship shown in FIG. 10, actually θᵢ₊₁ is determined according to Δνᵢ and Δcᵢ. That is, position information and orientation information of the mobile phone after change is determined according to position information and orientation information of the mobile phone before change in a communication process and variation information of displacement and direction of the microphone array provided by the gyroscope, thereby determining DOA θᵢ₊₁ of the sound source at this point.

The following will conclude DOA θᵢ₊₁ according to parameter information in a space. From FIG. 10, it can be seen that in a three-dimension space the origins bᵢ, cᵢ and the origins bᵢ₊₁, cᵢ₊₁ form two triangles. By using relationships between angles and sides of the triangle, it can be concluded that:

$$\begin{matrix}\begin{matrix}cos ( {θ}_{i} ) = \frac{{d}^{2} + {\vert {c}_{i} \vert}^{2} - {\vert {b}_{i} \vert}^{2}}{2 d \vert {c}_{i} \vert} \\ = \frac{{d}^{2} + ( {x}_{ci}^{2} + {y}_{ci}^{2} + {z}_{ci}^{2} ) - ( {x}_{bi}^{2} + {y}_{bi}^{2} + {z}_{bi}^{2} )}{2 d \sqrt{( {x}_{ci}^{2} + {y}_{ci}^{2} + {z}_{ci}^{2} )}} \\ = \frac{{d}^{2} + ( {x}_{ci}^{2} + {y}_{ci}^{2} + {z}_{ci}^{2} ) - ( \begin{matrix}{( {x}_{ci} - d cos {α}_{i} )}^{2} + \\ {( {y}_{ci} - d cos {β}_{i} )}^{2} + \\ {( {z}_{ci} - d cos {γ}_{i} )}^{2}\end{matrix} )}{2 d \sqrt{( {x}_{ci}^{2} + {y}_{ci}^{2} + {z}_{ci}^{2} )}} \\ = \frac{{x}_{ci} cos {α}_{i} + {γ}_{ci} cos {β}_{i} + {z}_{ci} cos {γ}_{i}}{\sqrt{( {x}_{ci}^{2} + {y}_{ci}^{2} + {z}_{ci}^{2} )}}\end{matrix} & ( 9 ) \\ \begin{matrix}cos ( {θ}_{i} ) = \frac{{d}^{2} + {\vert {c}_{i + 1} \vert}^{2} - {\vert {b}_{i + 1} \vert}^{2}}{2 d \vert {c}_{i} \vert} \\ = \frac{\begin{matrix}{d}^{2} + ( {x}_{c ( i + 1 )}^{2} + {y}_{c ( i + 1 )}^{2} + {z}_{c ( i + 1 )}^{2} ) - \\ ( {x}_{b ( i + 1 )}^{2} + {y}_{b ( i + 1 )}^{2} + {z}_{b ( i + 1 )}^{2} )\end{matrix}}{2 d \sqrt{( {x}_{ci}^{2} + {y}_{ci}^{2} + {z}_{ci}^{2} )}} \\ = \frac{\begin{matrix}{d}^{2} + ( {x}_{c ( i + 1 )}^{2} + {y}_{c ( i + 1 )}^{2} + {z}_{c ( i + 1 )}^{2} ) - \\ ( \begin{matrix}{( {x}_{c ( i + 1 )} - d cos {α}_{i + 1} )}^{2} + \\ {( {y}_{c ( i + 1 )} - d cos {β}_{i + 1} )}^{2} + \\ {( {z}_{c ( i + 1 )} - d cos {γ}_{i + 1} )}^{2}\end{matrix} )\end{matrix}}{2 d \sqrt{( {x}_{ci}^{2} + {y}_{ci}^{2} + {z}_{ci}^{2} )}} \\ = \frac{{x}_{c ( i + 1 )} cos {α}_{i + 1} + {γ}_{c ( i + 1 )} cos {β}_{i + 1} + {z}_{c ( i + 1 )} cos {γ}_{i + 1}}{\sqrt{( {x}_{c ( i + 1 )}^{2} + {y}_{c ( i + 1 )}^{2} + {z}_{c ( i + 1 )}^{2} )}}\end{matrix} & ( 10 )\end{matrix}$$

The equations (7) and (8) are taken into the above equations and it can be determined that:

$$\begin{matrix}cos ( {θ}_{i + 1} ) = \frac{{x}_{c ( i + 1 )} cos {α}_{i + 1} + {y}_{c ( i + 1 )} cos {β}_{i + 1} + {z}_{c ( i + 1 )} cos {γ}_{i + 1}}{\sqrt{( {x}_{c ( i + 1 )}^{2} + {y}_{c ( i + 1 )}^{2} + {z}_{c ( i + 1 )}^{2} )}} \\ = \frac{\begin{matrix}( {x}_{ci} + Δ {x}_{ci} ) cos ( {α}_{i} + {Δα}_{i} ) + \\ ( {y}_{ci} + Δ {y}_{ci} ) cos ( {β}_{i} + {Δβ}_{i} ) + \\ ( {z}_{ci} + Δ {z}_{ci} ) cos ( {γ}_{i} + Δ {γ}_{i} )\end{matrix}}{\sqrt{( {( {x}_{ci} + Δ {x}_{ci} )}^{2} + {( {y}_{ci} + Δ {y}_{ci} )}^{2} + {( {z}_{ci} + Δ {z}_{ci} )}^{2} )}}\end{matrix} \qquad ( 11 )$$

From the above equations (9), (10), and (11), it can be seen that after orientation of the mobile phone changes, orientation of the microphone array accordingly changes. The reference DOA before change is θᵢ, and this parameter is known, thus the corresponding position and direction of the microphone array are also known. The parameters cᵢ and vᵢ are uniquely determined. After change, the reference DOA changes to be θⱼ₊₁, and at this point θᵢ₊₁ is unknown, but can be determined in combination with the parameters cᵢ and vᵢ, and the unique orientation variation information Δvᵢ and Δcᵢ provided by the gyroscope, that is, according to the equation (11). In sum, if the status information of position and direction of the mobile phone before change is known, then after change, DOA after change can be determined according to the information provided by the gyroscope. That is, if the information of position and direction of the microphone array of the mobile phone are known when a communication for conversation is established, that is c₀ and v₀, then by means of the unique orientation variations provided by the gyroscope, the initial DOA θ₀ and all the subsequent DOA after posture of the mobile phone changes can be determined. Without the information provided by the gyroscope, a more complex beam forming methods and DOA estimation method may be needed. Comparing to the simple equation for determining DOA provided by the equation (11), the DOA estimation algorithm is very complex and time consuming, and is less accurate than using the information provided by the gyroscope and the computing solution provided by the equation (11).

It should be noted that initial information of position and direction of the microphone array when a communication for conversation is established can be determined by the use of the automatic estimation method for DOA. Although initial position data is acquired by the use of the automatic estimation method for DOA, during subsequent dynamic change in positions of the mobile phone, comparing to the method of adopting automatic estimation method for DOA during the whole process, the method of estimating DOA by means of the gyroscope can greatly enhance the processing speed of the speech processing method of the present disclosure, has good real-time performance, can reduce load of the terminal processor, and more importantly, can achieve better noise reduction effect.

According to an example implementation of the present disclosure, a program product stored in a non-volatile machine readable medium for speech processing is provided. The program product includes machine executable instructions configured to enable the computing system to execute the following steps: acquiring position data variations of a sound collection unit array of a terminal relative to a user sound source, and correcting direction of arrival (DOA) of the sound collection unit array according to the position data variations,

According to an example implementation of the present disclosure, a non-volatile machine readable medium which includes a program product for speech processing is further provided. The program product includes machine executable instructions configured to enable the computing system to execute the following steps: acquiring position data variations of a sound collection unit array of a terminal relative to a user sound source, and correcting direction of arrival (DOA) of the sound collection unit array according to the position data variations,

According to an example implementation of the present disclosure, a machine readable program is provided, and the program can enable the machine to execute any of the speech processing methods provided by all the above technical solutions.

According to an example implementation of the present disclosure, a storage medium storing a machine readable program is further provided. Wherein, the machine readable program can enable the machine to execute any of the speech processing methods provided by all the above technical solutions.

The technical solution of the present disclosure will be illustrated in conjunction with the accompanying drawings. The terminal uses the gyroscope to obtain orientation variation information during a communication process, and uses these information to correct some parameters of the speech noise reduction algorithm based on the multiple microphone array in time, so that a noise reduction algorithm is provided with self-adaptive ability, the noise reduction algorithm can be adjusted self-adaptively according to random change in postures of the user in a communication process, accordingly the best noise effect can be achieved. Meanwhile, as orientation variation information of the terminal is acquired from the gyroscope, dependency on the terminal processor is greatly reduced and power consumption is further reduced.

The foregoing descriptions are merely preferred implementations of the present disclosure, rather than limiting the present disclosure. Various modifications and alterations may be made to the present disclosure for those skilled in the art. Any modification, equivalent substitution, improvement or the like made within the spirit and principle of the present disclosure shall fall into the protection scope of the present disclosure.

What is claimed is:

1. A method for processing speech, comprising:
acquiring position data variations of a sound collection unit array of a terminal relative to a user sound source;
correcting, by the terminal, direction of arrival (DOA) of the sound collection unit array according to the position data variations; and
performing, by the terminal, filter processing on sound signals acquired by the sound collection unit.

2. The method of claim 1, wherein the acquiring the position data variations of the sound collection unit array of the terminal relative to the user sound source comprises acquiring the position data variations of the sound collection unit array of the terminal relative to the user sound source using a gyroscope of the terminal, and wherein the position data variations comprise a displacement variation of a reference sound collection unit and an angle variation of the sound collection unit array line.

3. The method of claim 1, wherein the correcting DOA of the sound collection unit array according to the position data variations comprises:
acquiring initial position data of the reference sound collection unit of the sound collection unit array relative to the user sound source and initial position data of the sound collection unit array line of the sound collection unit array relative to the user sound source, wherein the initial position data include initial coordinate data of the reference sound collection unit and initial angle data of the sound collection unit array line; and
computing an angle of arrival between current sound wave direction of the user sound source and a preset normal of the sound collection unit array line.

4. The method of claim 3, further comprising:
acquiring the initial position data of the reference sound collection unit relative to the user sound source and the initial position data of the sound collection unit array line relative to the user sound source using an automatic searching method for DOA.

5. The method of claim 3, further comprising:
establishing a coordinate system with the user sound source as a coordinate origin; and
determining the angle of arrival according to the following equation:
$$cos ( {θ}_{i + 1} ) = \frac{\begin{matrix}( {x}_{ci} + Δ {x}_{ci} ) cos ( {α}_{i} + Δ {α}_{i} ) + \\ ( {y}_{ci} + Δ {y}_{ci} ) cos ( {β}_{i} + {Δβ}_{i} ) + \\ ( {z}_{ci} + Δ {z}_{ci} ) cos ( {γ}_{i} + {Δγ}_{i} )\end{matrix}}{\sqrt{( {( {x}_{ci} + Δ {x}_{ci} )}^{2} + {( {y}_{ci} + Δ {y}_{ci} )}^{2} + {( {z}_{ci} + Δ {z}_{ci} )}^{2} )}}$$
wherein θᵢ₊₁ is the angle of arrival, (x_{ci}, y_{ci}, z_{ci}) is initial coordinate data of the reference sound collection unit in the coordinate system, (αᵢ, βᵢ, γᵢ) is initial angle data of the sound collection unit array line in the coordinate system, (Δx_{ci}, Δy_{ci}, Δz_{ci}) is a displacement variation of the reference sound collection unit in the coordinate system, and (Δαᵢ, Δβᵢ, Δγᵢ) is an angle variation of the sound collection unit array line in the coordinate system.

6. The method of claim 5, further comprising:
acquiring the initial position data of the reference sound collection unit relative to the user sound source and the initial position data of the sound collection unit array line relative to the user sound source using an automatic searching method for DOA.

7. A speech processing apparatus, comprising:
a storage unit storing computer-readable program codes; and
a processor configured to execute the computer-readable program codes to perform operations comprising:
acquiring position data variations of a sound collection unit array of a terminal relative to a user sound source;
correcting direction of arrival (DOA) of the sound collection unit array according to the position data variations; and
performing filter processing on sound signals acquired by the sound collection unit.

8. The speech processing apparatus of claim 7, wherein acquiring the position data variations of the sound collection unit array of the terminal relative to the user sound source comprises acquiring the position data variations of the sound collection unit array of the terminal relative to the user sound source using a gyroscope, and wherein the position data variations comprise a displacement variation of a reference sound collection unit and an angle variation of the sound collection unit array line.

9. The speech processing apparatus of claim 7, wherein the correcting DOA of the sound collection unit array according to the position data variations comprises:
acquiring initial position data of the reference sound collection unit of the sound collection unit array relative to the user sound source and initial position data of the sound collection unit array line of the sound collection unit array relative to the user sound source, wherein the initial position data include initial coordinate data of the reference sound collection unit and initial angle data of the sound collection unit array line; and
computing an angle of arrival between current sound wave direction of the user sound source and a preset normal of the sound collection unit array line.

10. The speech processing apparatus of claim 9, wherein the initial position data of the reference sound collection unit relative to the user sound source and the initial position data of the sound collection unit array line relative to the user sound source are acquired using an automatic searching method for DOA.

11. The speech processing apparatus of claim 9, wherein a coordinate system is established with the user sound source as a coordinate origin, and the angle of arrival is determined according to the following equation:
$$cos ( {θ}_{i + 1} ) = \frac{\begin{matrix}( {x}_{ci} + Δ {x}_{ci} ) cos ( {α}_{i} + Δ {α}_{i} ) + \\ ( {y}_{ci} + Δ {y}_{ci} ) cos ( {β}_{i} + {Δβ}_{i} ) + \\ ( {z}_{ci} + Δ {z}_{ci} ) cos ( {γ}_{i} + {Δγ}_{i} )\end{matrix}}{\sqrt{( {( {x}_{ci} + Δ {x}_{ci} )}^{2} + {( {y}_{ci} + Δ {y}_{ci} )}^{2} + {( {z}_{ci} + Δ {z}_{ci} )}^{2} )}}$$
wherein θᵢ₊₁ is the angle of arrival, (x_{ci}, y_{ci}, z_{ci}) is initial coordinate data of the reference sound collection unit in the coordinate system, (αᵢ, βᵢ, γᵢ) is initial angle data of the sound collection unit array line in the coordinate system, (Δx_{ci}, Δy_{ci}, Δz_{ci}) is a displacement variation of the reference sound collection unit in the coordinate system, and (Δαᵢ, Δβᵢ, Δγᵢ) is an angle variation of the sound collection unit array line in the coordinate system.

12. The speech processing apparatus of claim 11, wherein the initial position data of the reference sound collection unit relative to the user sound source and the initial position data of the sound collection unit array line relative to the user sound source are acquired using an automatic searching method for DOA.

13. A non-transitory storage medium having stored thereon computer-readable instructions executable by a speech processing apparatus to cause the speech processing apparatus to perform operations comprising:
acquiring position data variations of a sound collection unit array of a terminal relative to a user sound source;
correcting direction of arrival (DOA) of the sound collection unit array according to the position data variations; and
performing filter processing on sound signals acquired by the sound collection unit.

14. The non-transitory storage medium of claim 13, wherein the position data variations are acquired using a gyroscope, the position data variations comprise a displacement variation of a reference sound collection unit and an angle variation of the sound collection unit array line.

15. The non-transitory storage medium of claim 13, wherein the correcting DOA of the sound collection unit array according to the position data variations comprises:
acquiring initial position data of the reference sound collection unit of the sound collection unit array relative to the user sound source and initial position data of the sound collection unit array line of the sound collection unit array relative to the user sound source, wherein the initial position data include initial coordinate data of the reference sound collection unit and initial angle data of the sound collection unit array line; and
computing an angle of arrival between current sound wave direction of the user sound source and a preset normal of the sound collection unit array line.

16. The non-transitory storage medium of claim 15, wherein the initial position data of the reference sound collection unit relative to the user sound source and the initial position data of the sound collection unit array line relative to the user sound source are acquired using an automatic searching method for DOA.

17. The non-transitory storage medium of claim 15, wherein a coordinate system is established with the user sound source as the coordinate origin, and the angle of arrival is determined according to the following equation:
$$cos ( {θ}_{i + 1} ) = \frac{\begin{matrix}( {x}_{ci} + Δ {x}_{ci} ) cos ( {α}_{i} + Δ {α}_{i} ) + \\ ( {y}_{ci} + Δ {y}_{ci} ) cos ( {β}_{i} + {Δβ}_{i} ) + \\ ( {z}_{ci} + Δ {z}_{ci} ) cos ( {γ}_{i} + {Δγ}_{i} )\end{matrix}}{\sqrt{( {( {x}_{ci} + Δ {x}_{ci} )}^{2} + {( {y}_{ci} + Δ {y}_{ci} )}^{2} + {( {z}_{ci} + Δ {z}_{ci} )}^{2} )}}$$
wherein θᵢ₊₁ is the angle of arrival, (x_{ci}, y_{ci}, z_{ci}) is initial coordinate data of the reference sound collection unit in the coordinate system, (αᵢ, βᵢ, γᵢ) is initial angle data of the sound collection unit array line in the coordinate system, (Δx_{ci}, Δy_{ci}, Δz_{ci}) is a displacement variation of the reference sound collection unit in the coordinate system, and (Δαᵢ, Δβᵢ, Δγᵢ) is an angle variation of the sound collection unit array line in the coordinate system.

18. The non-transitory storage medium of claim 17, wherein the initial position data of the reference sound collection unit relative to the user sound source and the initial position data of the sound collection unit array line relative to the user sound source are acquired using an automatic searching method for DOA.
